(19) United States
(12) Patent Application Publication
(10) Pub. No.: US 2002/0174778 A1
(43) Pub. Date: Nov. 28, 2002

(54) System for automated removal of waste cooking oil from fryer vats

(76) Inventor: Joseph A. Petrusha, Burr Ridge, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/156,359

(22) Filed: May 28, 2002

Related U.S. Application Data
(60) Provisional application No. 60/293,855, filed on May 25, 2001.

(51) Int. Cl. A47J 37/12

(52) U.S. Cl. 99/336; 99/344; 99/408

(57) ABSTRACT

A system for removing cooking oil from a fryer vat is provided. The system includes a storage tank for storing cooking oil. The storage tank is disposed remotely from the fryer vat and in fluid communication with the fryer vat through a fixed piping system. A pump is arranged to transfer cooking oil from the fryer vat to the storage tank through the fixed piping system. A shut-off valve for directing cooking oil transferred by the pump to the storage tank is also provided. The shut-off valve is movable between an open position wherein the shut-off valve permits cooking oil to flow through the fixed piping system to the storage tank and a closed position wherein the shut-off valve blocks flow of cooking oil through the fixed piping system to the storage tank. A level sensor is arranged to detect whether the cooking oil in the storage tank is at a predetermined level. When the level sensor detects that the cooking oil in the storage tank is at the predetermined level the shut-off valve moves from the open position to the closed position or the pump stops transferring cooking oil to the storage tank. An alarm device can provide an audio or visual alarm signal when the level sensor detects that the cooking oil is at the predetermined level.

### CROSS-REFERENCE TO RELATED PATENT APPLICATIONS

This application claims the benefit of U.S. Provisional Application No. 60/293,855, filed May 25, 2001.

### FIELD OF THE INVENTION

This invention generally relates to systems for handling cooking oils and, more particularly, to an improved system for collecting waste, spent cooking oil from fryer vats.

### BACKGROUND OF THE INVENTION

Historically, a number of techniques have been used for removing waste cooking oil or grease from fryer vats in a restaurant environment. These techniques generally involve transferring the waste cooking oil which is removed from the individual fryer vats to a remote bulk storage container, such as a tank or drum, which can be arranged either inside or outside the restaurant. The waste cooking oil typically remains in the bulk storage container until it is picked-up for delivery to a rendering facility where it can be recycled for use in products such as animal feed supplements.

The techniques which have been and are currently being used suffer from the drawback that they typically require restaurant employees to physically handle and move containers filled with cooking oil. For example, until recently, it was common for restaurant employees to drain the fryer vats into containers which were then hand carried to a refuse area where the waste cooking oil would be transferred by hand into a larger bulk storage container. As can be appreciated, the manual handling of the containers of cooking oil which is associated with this technique creates a significant risk of splashing and spilling of the cooking oil. If the cooking oil is still at an elevated temperature, this splashing and spilling could result in the employee handling the cooking oil being burned. Moreover, spilled cooking oil can be quite slippery which creates a hazard for other employees as well. The splashing and spilling of the cooking oil also could pose health hazards particularly if it occurs in an area of the restaurant where food is prepared.

One commonly used technique which has been developed to reduce the amount of manual handling of the cooking oil involves the use of wheeled caddies which can fit underneath the fryers and receive the spent cooking oil upon the opening of a drain valve in the fryer. Once the spent cooking oil is drained from the fryer vat, the caddie is wheeled to a remote tank to which the spent cooking oil is then transferred. While this system reduces the risk of spills when handling the waste cooking oil, this technique is quite labor intensive and time consuming. The storage of the wheeled caddies can also consume valuable floor space.

### SUMMARY OF THE INVENTION

A system for removing cooking oil from a fryer vat is provided. The system includes a storage tank for storing cooking oil. The storage tank is disposed remotely from the fryer vat and in fluid communication with the fryer vat through a fixed piping system. A pump is arranged to transfer cooking oil from the fryer vat to the storage tank through the fixed piping system.

A shut-off valve for directing cooking oil transferred by the pump to the storage tank is also provided. The shut-off valve is movable between an open position wherein the shut-off valve permits cooking oil to flow through the fixed piping system to the storage tank and a closed position wherein the shut-off valve blocks flow of cooking oil through the fixed piping system to the storage tank. A level sensor is arranged to detect whether the cooking oil in the storage tank is at a predetermined level.

When the level sensor detects that the cooking oil in the storage tank is at the predetermined level the shut-off valve moves from the open position to the closed position or the pump stops transferring cooking oil to the storage tank. An alarm device can provide an audio or visual alarm signal when the level sensor detects that the cooking oil is at the predetermined level.

These and other features and advantages of the invention will be more readily apparent upon reading the following description of a preferred exemplary embodiment of the invention and upon reference to the accompanying drawings wherein:

### BRIEF DESCRIPTION OF THE DRAWINGS

FIG. 1 is a schematic perspective view of an illustrative waste cooking oil handling system constructed in accordance with the present invention which provides for automated removal of waste cooking oil to a load-out tank.

FIG. 2 is a schematic plan view of the waste cooking oil handling system of FIG. 1.

FIG. 3 is a schematic side elevation view of the waste cooking oil handling system of FIG. 1.

FIG. 4 is an enlarged schematic side elevation view of the waste cooking oil handling system of FIG. 1 showing the connection to the load-out tank.

FIG. 5 is partially exploded perspective view of an exemplary load-out tank for use in the waste cooking oil handling system of FIG. 1.

FIG. 6 is a schematic drawing of an exemplary controller for use in the waste cooking oil handling system of FIG. 1.

FIG. 7 is a schematic drawing of a further embodiment of a waste cooking oil handling system according to the present invention.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

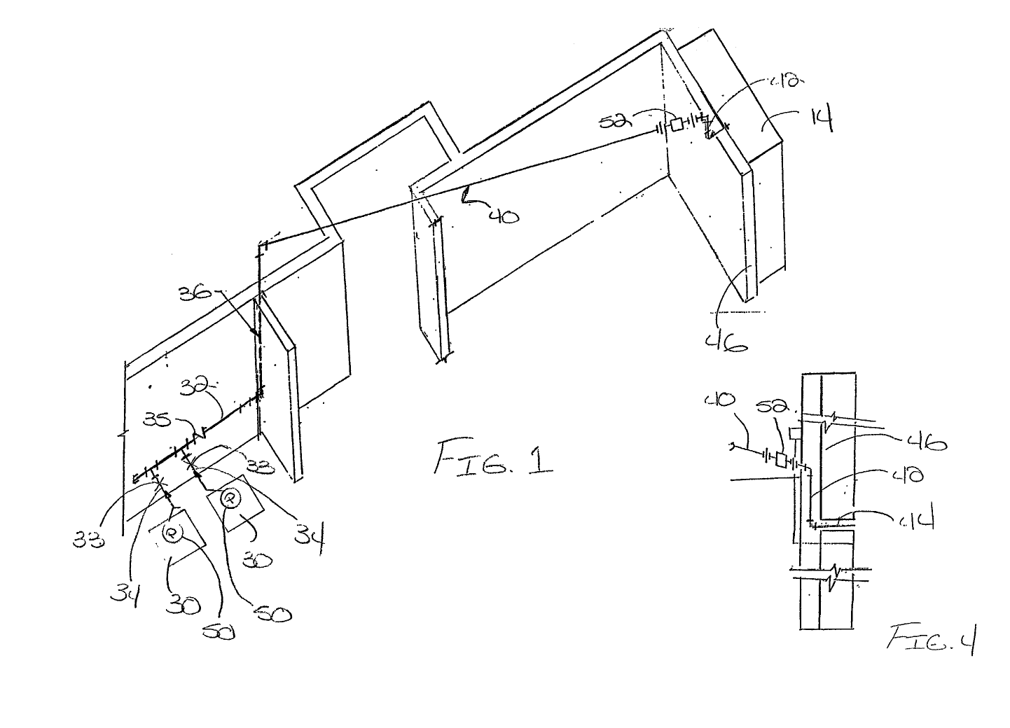

Referring now more particularly to FIG. 1, there is shown a schematic block diagram of an illustrative waste cooking oil handling system constructed in accordance with the present invention for automatically removing spent cooking oil from one or more fryer vats. The present invention substantially eliminates the need for manual handling of waste cooking oil. Thus, messy and dangerous cooking oil spills are substantially eliminated. Moreover, the present invention makes the cooking oil changing process much less labor intensive and time-consuming than the commonly used manual techniques.

While the present invention is described in connection with the removal of cooking oil from a plurality of fryer vats, those skilled in the art will appreciate that the distribution system of the present invention could be used in conjunction with a single vat. Moreover, while the invention is described in the context of a restaurant environment, it will be readily appreciated that the present invention is equally applicable to the removal of other materials such as grease from other types of cooking equipment such as may be used in food preparation plants. Thus, as used herein, the term cooking oil refers to any fluid such as cooking oil, grease, shortening and the like which are used to cook food. Moreover, the term fryer vat is used to refer to any cooking equipment that uses such a fluid.

For storing the spent cooking oil, the illustrated handling system includes a waste oil bulk load-out tank 14 as shown in FIGS. 1-3. The load-out tank 14 preferably has a capacity several times the capacity of the fryer vat, such as for example 100-250 gallons. The load-out tank 14 can have a conventional design and can be located either inside or, as in this case, outside the restaurant. If the load-out tank 14 is arranged inside the restaurant, it is preferred that hook-ups be provided on an outside wall of the restaurant so that the tank can be easily drained via a pumper truck on the outside of the building. An example of a suitable load-out tank that can be located outside the restaurant is the Model ME480E OUTDOOR RECYCLER sold by Mahoney Environmental of Joliet Illinois. An example of a suitable load-out tank that can be located inside the restaurant is the Model ME 1103 INDOOR RECYCLER sold by Mahoney Environmental.

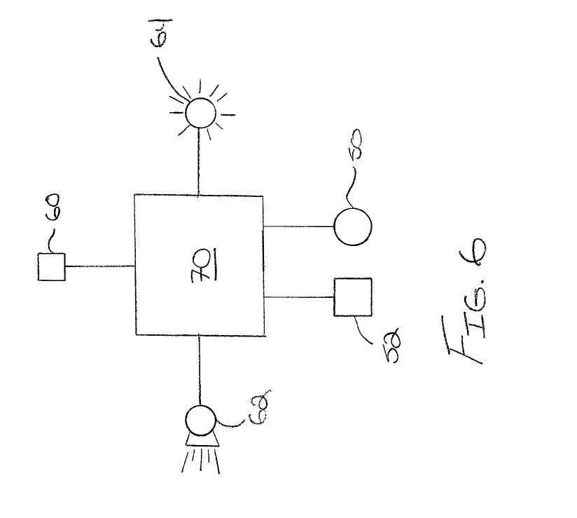

Because the cooking oil solidifies at room temperature, the load-out tank 14 can be provided with a heating element which maintains the cooking oil at an elevated temperature, for example 110° F., to ensure it can be readily pumped. As shown in FIG. 5, the heating element 18 can have an L-shaped tubular configuration including a hollow, substantially vertical tube 19 and a hollow, substantially horizontal tube as is described in greater detail in U.S. Pat. No. 5,850,503, which is incorporated herein by reference. The L-shaped heating element 18 is filled with a heat transfer fluid which is heated by a heating coil 22. In order to help prevent an over pressure condition, a safety valve 24 may be provided on either the horizontal or vertical legs.

For transferring the waste cooking oil from one or more fryer vats to the load-out station 14, a piping system is provided. As shown in FIGS. 1-3, the piping system interconnects the load-out station 14 with, in the case of the illustrated embodiment, a plurality of fryers 30. Adjacent the fryers 30, the piping system includes a manifold 32 to which the fryers are connected. In particular, the manifold 32 can be connected to the filter systems of the individual fryers by respective high temperature hoses 34 or any other suitable conduits. Each of the connections can include a respective on/off valve 33 that can be used to control the flow of waste cooking oil from the fryer 30 into the piping system. In the illustrated embodiment, a check valve 35 is provided in the manifold 32 downstream from the connections 34 to the individual fryers 20 to prevent waste cooking oil from back-flowing into the manifold.

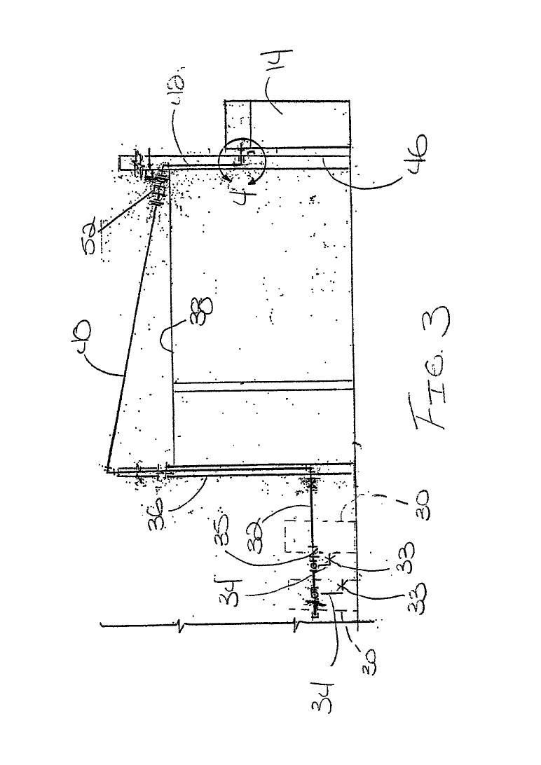

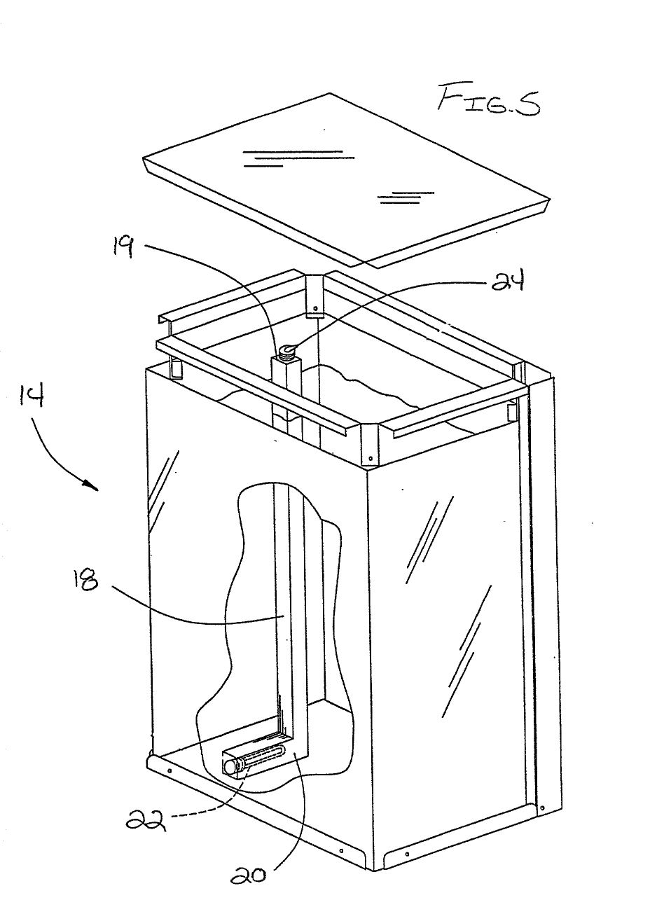

In the illustrated embodiment, a substantially vertical pipe segment 36 is located just downstream of the manifold. This vertical segment 36 can be located out of sight such as inside an interior wall of the restaurant and serves to raise the piping system to a level at which it is out of the way, in this instance, above the ceiling 38 of the restaurant as shown in FIG. 3. The vertical segment 35, in turn, connects into a substantially horizontal pipe segment 40 that extends across the restaurant to where the load-out tank 14 is located. There, another vertical pipe segment 42 (see, e.g., FIG. 4), which again can extend inside a wall of the restaurant, is provided that brings the piping system down to a level at which it can be tied into the load-out tank 14. In this case, the piping system includes a final segment 44 which extends through an exterior wall 46 of the restaurant to the load-out tank 14 as best shown in FIG. 4.

To prevent the waste cooking oil from accumulating, the horizontal piping segments can be sloped such that the waste cooking oil will drain towards the load-out station 14 such as shown in FIG. 3. The interior of the piping also can be coated so as to facilitate drainage of the cooking oil. In cases where sloping the piping is not an option, for example, because of the long distance between the fryers and the load-out tank and the limited space above the drop ceilings in the restaurant, at least the substantially horizontal segments of the piping system can be heated so as to prevent the cooking oil therein from solidifying. For example, the piping can be heated by surrounding the metal piping with a pipe jacket filled with a heat transfer fluid. The heat transfer fluid can be heated via a heating element and circulated through the pipe jackets by a pump.

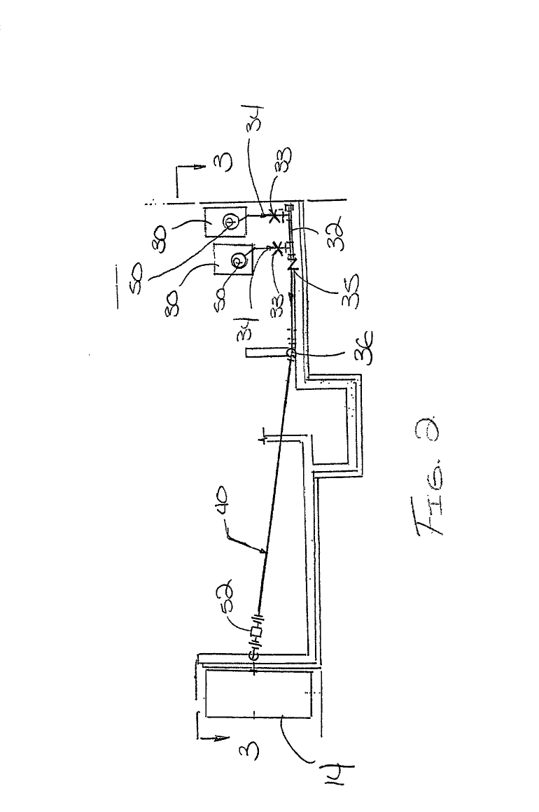

For moving the cooking oil through the piping system to the load-out tank 14, one or more pumps may be provided. For example, in the illustrated embodiment, the filter pumps 50 (shown schematically in FIGS. 1 and 2) provided in the individual fryers 30 are used to force the waste oil through the piping system to the load-out tank 14. Accordingly, the hoses 34 connecting the manifold 32 to the individual fryers 30 communicate with the respective fryer's filter pump 50 so that when the on/off valve 33 is opened, the waste oil will be driven by the pump through the hose into the manifold. Alternatively, one or more pumps can be provided in the piping system that are separate from the individual fryers.

To prevent the load-out tank 14 from overflowing, the system is configured to automatically shut-off when the load-out tank is full. If such overflow protection is not provided there is the possibility that the spent cooking oil could be pumped out of the tank vent and create a hazardous situation for employees of the restaurant as well as unsanitary conditions that could pose a health hazard with regard to the preparation of food. To this end, the load-out tank 14 includes a level sensor 60 such as a float switch that detects when the fluid level in the load-out tank 14 reaches a predetermined level. In one embodiment, the level sensor 60 is in communication with a shut-off valve 52, for example an electrically operable solenoid valve, in the piping system. In the illustrated embodiment, the shut-off valve 52 is located adjacent the downstream end of the horizontal pipe segment 40. When the cooking oil in the load-out tank 14 reaches the predetermined level, the level sensor 60 is triggered. This signals the shut-off valve 52 to close, thereby stopping the flow of waste cooking oil to the load-out tank 14. The level sensor 60 can also communicate with an alarm device such as a horn 62 or indicator light 64 that can provide an audible or visual signal when the load-out tank 14 is full. For example, the horn 62 could be arranged adjacent the fryers 30 that would sound for a predetermined amount of time to signal that the load-out tank 14 was full. The horn 62 could then repeat periodically until the level of cooking oil in the load-out tank 14 is reduced. Alternatively, the system could be configured to shut down the pump 50 when the load-out tank 14 is full or to place the pump 50 into a recycle mode wherein the cooking oil is returned to the fryer 30.

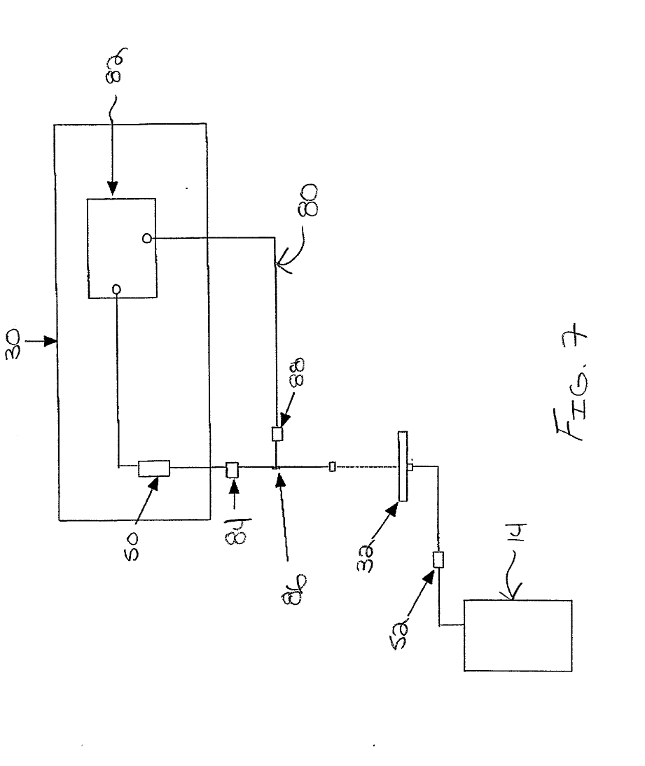

A controller 70 can be provided which communicates with and controls the level sensor 60, shut-off valve 52, alarm horn or light 62, 64 and/or pump 50 as shown in FIG. 6. For example, the controller 70 could be configured to direct the shut-off valve 52 to move from the open to the closed position and actuate the horn 62 and indicator light 64 when the level sensor 60 detects that the load-out tank 14 is full. Alternatively, the controller 70 could direct the pump 50 to shut-off or recycle cooking oil back to the fryer 30 when the level sensor 60 detects that the load-out tank 14 is full. In one embodiment, the control panel for the load-out tank 14 can be modified as necessary to operate as the controller 70. Examples of suitable solenoid shut-off valve are the Model 8267G23 2-way direct-acting solenoid valve available from Asco and the Type 72228 direct lift diaphragm solenoid valve available from Parker Hannifin. An example of a suitable level sensor is the LS-1959 series single station level switch available from Gems Sensors.

With the distribution system of the present invention, when it becomes time to change out the cooking oil in a fryer vat, an operator need only open the appropriate on/off valve 33 and activate the pump 50 which drains the cooking oil out of the fryer vat 30. The waste cooking oil is then directed through the piping to the load-out tank 14. Once the fryer vat is completely drained, and cleaned, as necessary, the operator can fill the fryer with new cooking oil. Once the load-out tank 14 is filled with spent cooking oil, the system will be automatically shut-off, for example via the shut-off valve 52, so as to prevent any spillage out of the load-out tank 14. The cooking oil can be pumped from the load-out tank to a truck which hauls away the spent cooking oil for disposal.

For fryers using roller pumps, the illustrated arrangement of the solenoid valve is sufficient to shut-off the flow of waste cooking oil to the load-out tank. If the system is connected into a fryer using a gear pump, or if the system otherwise uses a gear pump to move the cooking oil, a recirculation line should be placed in the piping system downstream from the pump.

An exemplary embodiment of a system according to the present invention that utilizes a gear pump is illustrated in FIG. 7. The system illustrated in FIG. 7 includes a load-out station 14 that is connected to a fryer 30 by a fixed piping system (note components the same or similar to those used in the FIGS. 1-6 embodiment are given the same reference numbers). A gear pump 50 is provided which moves the cooking oil through the piping system to the load-out tank 14. To prevent the load-out tank 14 from overflowing, the piping system again includes a shut-off valve 52 that closes when the cooking oil in the load-out tank 14 reaches a predetermined level and stops the flow of cooking oil to the load-out tank. The piping system also includes a manifold 32 to which a plurality of fryers can be attached.

To allow for the cooking oil to recirculate back to the fryer 30 when the shut-off valve closes, the illustrated piping arrangement has a recirculation line 80 that extends back to the fryer filter pan 82 from a point downstream of the pump 50. In this case, a check valve 84 is provided between the gear pump 50 and the tee connection 86 to the recirculation line 80 that prevents flow back to the pump 50. To ensure that the recirculation line 80 only opens when the shut-off valve 52 is closed, the recirculation line 80 is adapted to be activated only when the pressure in the piping system exceeds a predetermined value (e.g., 60 psi). To this end, the illustrated recirculation line 80 includes a reverse flow check valve 88 which opens the recirculation line 80 back to the fryer filter pan 82 when the pressure in the piping system rises to the predetermined value because of closure of the shut-off valve 52. When the recirculation line 80 is activated, the pump 50 will continue to recirculate cooking oil back to the fryer pan 82 until the shut-off valve 52 re-opens allowing flow into the load-out tank 14 thereby relieving the pressure in the system.

It will be appreciated that the filling of the fryer with fresh cooking oil can also be done via a direct connect piping system. With such an arrangement, a tank of fresh cooking oil is provided which is connected to the fryer by piping and the fryer is filled by operation of a pump which transfers the fresh cooking oil from the tank to the fryer through the piping.

From the foregoing it can be seen that a cooking oil distribution system has been provided which substantially eliminates the need for any manual handling of the waste cooking oil. Accordingly, messy, and potentially dangerous, oil splashing and spilling of hot cooking oil is avoided. Moreover, the cooking oil distribution system much quicker and more efficient than commonly used methods for changing oil in fryer vats which require employees to transfer the used cooking oil away from the fryer.

While this invention has been described with an emphasis upon preferred embodiments, it will be obvious to those of ordinary skill in the art that variations of the preferred embodiments may be used and that it is intended that the invention may be practiced otherwise than as specifically described herein. Accordingly, this invention includes all modifications encompassed within the spirit and the scope of the invention.

What is claimed is:

1. A system for removing cooking oil from a fryer vat comprising:
a storage tank for storing cooking oil, the storage tank being disposed remotely from the fryer vat and in fluid communication with the fryer vat through a fixed piping system,
a pump arranged to transfer cooking oil from the fryer vat to the storage tank through the fixed piping system,
an electrically operable shut-off valve for directing cooking oil transferred by the pump to the storage tank, the shut-off valve being movable between an open position wherein the shut-off valve permits cooking oil to flow through the fixed piping system to the storage tank and a closed position wherein the shut-off valve blocks flow of cooking oil through the fixed piping system to the storage tank, and
a level sensor in electrical communication with the shut-off valve and arranged to detect whether the cooking oil in the storage tank is at a predetermined level, wherein when the level sensor detects that the cooking oil in the storage tank is at the predetermined level the shut-off valve moves from the open position to the closed position.

2. The system of claim 1 further including a heater arranged to heat the cooking oil stored in the storage tank.

3. The system of claim 1 wherein the fixed piping system includes a generally horizontally extending portion that is sloped to facilitate draining of the cooking oil out of the generally horizontally extending portion.

4. The system of claim 1 wherein the fixed piping system includes a generally vertically extending portion that is coated with a material which facilitates drainage of the cooking oil out of the generally vertically extending portion.

5. The system of claim 1 wherein the fixed piping system includes a recirculation line extending from a point downstream of the pump back to the fryer vat, the recirculation being configured to open when the pressure in fixed piping system exceeds a predetermined value.

6. A system for removing cooking oil from a fryer vat comprising:
a storage tank for storing cooking oil, the storage tank being disposed remotely from the fryer vat and in fluid communication with the fryer vat through a fixed piping system,
a pump arranged to transfer cooking oil from the fryer vat to the storage tank through the fixed piping system,
a shut-off valve for directing cooking oil transferred by the pump to the storage tank, the shut-off valve being movable between an open position wherein the shut-off valve permits cooking oil to flow through the fixed piping system to the storage tank and a closed position wherein the shut-off valve blocks flow of cooking oil through the fixed piping system to the storage tank,
a level sensor arranged to detect whether the cooking oil in the storage tank is at a predetermined level,
an alarm device for providing an audio or visual alarm signal, and
a controller in communication with the level sensor, shut-off valve and alarm device, the controller directing the shut-off valve to move from the open to the closed position and the alarm device to provide the audio or visual alarm signal in response to the level sensor detecting the cooking oil at the predetermined level.

7. The system of claim 6 further including a heater arranged to heat the cooking oil stored in the storage tank.

8. The system of claim 6 wherein the fixed piping system includes a generally horizontally extending portion that is sloped to facilitate draining of the cooking oil out of the generally horizontally extending portion.

9. The system of claim 6 wherein the alarm device provides the audio or visual alarm signal continuously when the level sensor detects the cooking oil at the predetermined level.

10. The system of claim 6 wherein the alarm device provides the audio or visual alarm signal intermittently when the level sensor detects the cooking oil at the predetermined level.

11. The system of claim 6 wherein the controller further directs the shut-off valve to move from the closed to the open position and directs the alarm device to stop the audio or visual alarm signal when the level sensor stops detecting the cooking oil at the predetermined level after the detecting the cooking oil at the predetermined level.

12. The system of claim 6 wherein the alarm device comprises a horn.

13. The system of claim 6 wherein the alarm device comprises an indicator light.

14. The system of claim 6 wherein the fixed piping system includes a recirculation line extending from a point downstream of the pump back to the fryer vat, the recirculation being configured to open when the pressure in fixed piping system exceeds a predetermined value.

15. A system for removing cooking oil from a fryer vat comprising:
a storage tank for storing cooking oil, the storage tank being disposed remotely from the fryer vat and in fluid communication with the fryer vat through a fixed piping system,
a pump arranged to transfer cooking oil from the fryer vat to the storage tank through the fixed piping system, the pump being operable in a first mode in which the pump can transfer cooking oil from the fryer vat to the storage tank and in a second mode in which the pump can not transfer cooking oil from the fryer vat to the storage tank;
a level sensor arranged to detect whether the cooking oil in the storage tank is at a predetermined level,
an alarm device for providing an audio or visual alarm signal, and
a controller in communication with the level sensor, pump and alarm device, the controller directing the pump to operate in the second mode and the alarm device to provide the audio or visual alarm signal in response to the level sensor detecting the cooking oil at the predetermined level.

16. The system of claim 15 further including a heater arranged to heat the cooking oil stored in the storage tank.

17. The system of claim 15 wherein the alarm device provides the audio or visual alarm signal continuously when the level sensor detects the cooking oil at the predetermined level.

18. The system of claim 15 wherein the alarm device provides the audio or visual alarm signal intermittently when the level sensor detects the cooking oil at the predetermined level.

19. The system of claim 15 wherein the controller further directs the pump to operate in the first mode and directs the alarm device to stop the audio or visual alarm signal when the level sensor stops detecting the cooking oil at the predetermined level after the detecting the cooking oil at the predetermined level.

20. The system of claim 15 wherein the fixed piping system includes a recirculation line extending from a point downstream of the pump back to the fryer vat, the recirculation being configured to open when the pressure in fixed piping system exceeds a predetermined value.

21. The system of claim 15 wherein the second mode is a recirculation mode.

22. A method for removing cooking oil from a fryer vat comprising the steps of:
transferring the cooking oil from the fryer vat to a remotely located storage tank through a fixed piping system;
continuously monitoring the level of cooking oil in the storage tank;
providing an alarm signal when the level of cooking oil in the storage tank reaches a predetermined level; and
automatically shutting off the flow of cooking oil from the fryer vat to the storage tank through the fixed piping system when the cooking oil in the storage tank reaches a predetermined level.

23. The method of claim 18 further including the step of heating the cooking oil in the storage tank.

24. The method of claim 22 further including the step of automatically opening the flow of cooking oil from the fryer vat to the storage tank through the fixed piping system when the cooking oil in the storage tank drops below the predetermined level after reaching the predetermined level.

25. The method of claim 22 further including the step of stopping the alarm signal when the cooking oil in the storage tank drops below the predetermined level after reaching the predetermined level.

26. The method of claim 22 wherein the alarm signal is provided continuously when the level of cooking oil in the storage tank reaches the predetermined level.

27. The method of claim 22 wherein the alarm signal is provided intermittently when the level of cooking oil in the storage tank reaches the predetermined level.
